(19) United States
(12) Patent Application Publication
(10) Pub. No.: US 2008/0041835 A1
(43) Pub. Date: Feb. 21, 2008

(54) SEAT-ADJUSTMENT MECHANISM CAPACITOR-WELDING APPARATUS AND METHOD

(76) Inventor: Dagoberto Krambeck, Troy, MI (US)

Correspondence Address: HARNESS, DICKEY & PIERCE, P.L.C., P.O. BOX 828, BLOOMFIELD HILLS, MI, 48303, US

(21) Appl. No.: 11/839,204

(22) Filed: Aug. 15, 2007

Related U.S. Application Data
(60) Provisional application No. 60/837,970, filed on Aug. 16, 2006.

(51) Int. Cl. B23K 11/00

(52) U.S. Cl. 219/148; 219/162

(57) ABSTRACT

An adjustment assembly for a seat assembly includes an adjustment mechanism and a first structural component positioned proximate the adjustment mechanism to create at least one electrical path between the adjustment mechanism and the first structural component. The electrical path receives current from one side of one of the adjustment mechanism and the first structural component and transmits the current to the other of the adjustment mechanism and the first structural member to fuse the adjustment mechanism to the first structural component.

### CROSS-REFERENCE TO RELATED APPLICATIONS

This application claims the benefit of U.S. Provisional Application No. 60/837,970, filed on Aug. 16, 2006. The disclosure of the above application is incorporated herein by reference.

### FIELD

The present disclosure relates to seat-adjustment mechanisms, and more particularly, to an improved seat-adjustment mechanism assembly manufactured using a capacitor-welding process.

### BACKGROUND

The statements in this section merely provide background information related to the present disclosure and may not constitute prior art.

Vehicles typically incorporate a seat assembly including a seat-adjustment mechanism that allows for removal of and/or reconfiguration of the seat assembly. For example, the seat assembly may include at least one of a recliner assembly, a floor latch mechanism, and a kneel mechanism that allows a user to remove the vehicle seat from the vehicle and/or reconfigure a position of the vehicle seat relative to the vehicle.

Conventional seat-adjustment mechanisms typically include a housing supporting internal components of the seat-adjustment mechanism. Once assembled, the housing of the seat-adjustment mechanism provides a location to which the seat-adjustment mechanism may be fixedly attached to a structural component of the vehicle seat. For example, the seat-adjustment mechanism may be directly attached to a seat frame of the vehicle seat or, alternatively, may be fixedly attached to mounting brackets, which may then be fixedly attached to a seat frame of the vehicle seat.

Attaching seat-adjustment mechanisms directly to a structural component of a vehicle seat is typically accomplished through a spot-welding process or an arc-welding process. For example, a spot-welding process or an arc-welding process may be used to fuse the housing of the seat-adjustment mechanism to the structural component.

During such spot-welding and arc-welding processes, the seat-adjustment mechanism and the structural component are subjected to high temperatures over a prolonged period of time to ensure that the housing of the seat-adjustment mechanism properly fuses with the structural component. While adequately fusing the seat-adjustment mechanism and structural component together, the elevated temperatures may cause internal components of the seat-adjustment mechanism to become fused together and/or warp. Should the internal components of the seat-adjustment mechanism become warped and/or fused together, use of the seat-adjustment mechanism may be prohibited or degraded.

### SUMMARY

An adjustment assembly for a seat assembly includes an adjustment mechanism and a first structural component positioned proximate the adjustment mechanism to create at least one electrical path between the adjustment mechanism and the first structural component. The electrical path receives current from one side of one of the adjustment mechanism and the first structural component and transmits the current to the other of the adjustment mechanism and the first structural member to fuse the adjustment mechanism to the first structural component.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a seat assembly including a seat-adjustment mechanism manufactured using a capacitor-welding process in accordance with the present teachings;

FIG. 2 is an exploded view of the seat-adjustment mechanism of FIG. 1;

FIG. 3 is a cross-sectional view of the seat-adjustment mechanism of FIG. 1 in a pre-welded state detailing interaction between the seat-adjustment mechanism and a capacitor-welding apparatus;

FIG. 4 is a cross-sectional view of the seat-adjustment mechanism of FIG. 1 in a welded state detailing interaction between the capacitor-welding apparatus of FIG. 3 and the seat-adjustment mechanism;

FIG. 5 is a cross-sectional view of a seat-adjustment mechanism and structural component of a vehicle seat according to the principles of the present disclosure; and

FIG. 6 is a cross-sectional view of a seat-adjustment mechanism and structural component of a vehicle seat according to the principles of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

According to the principles of the present disclosure, an adjustment assembly is provided in which an adjustment mechanism is attached to a structural component using a capacitor-welding process. An electrical path is formed between a housing of the adjustment mechanism and the structural component to allow a capacitor-welding apparatus to join the adjustment mechanism and structural component. The capacitor-welding apparatus engages the adjustment mechanism and structural component proximate a single side of the structural component and therefore simplifies joining of the adjustment mechanism and structural component.

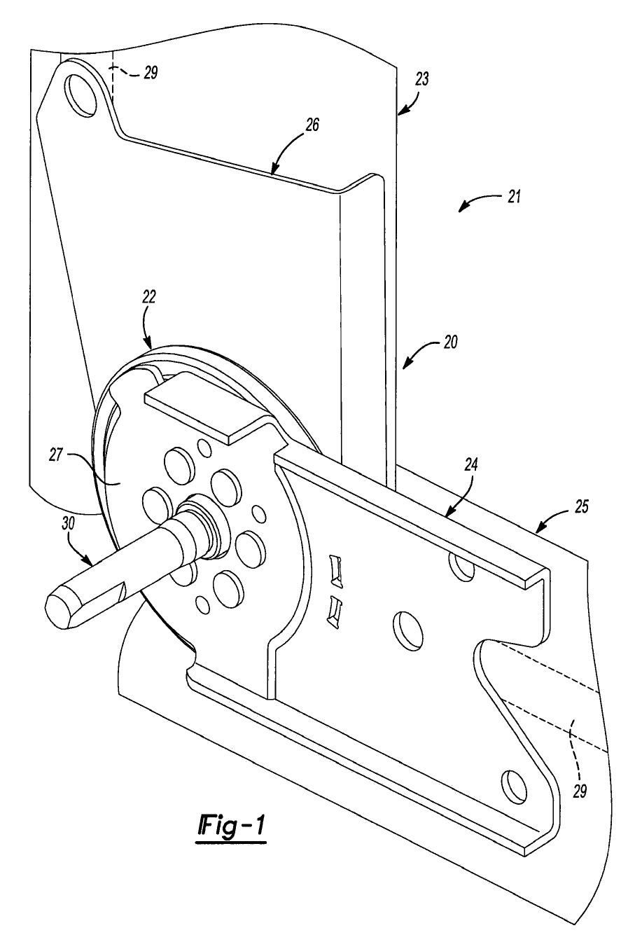

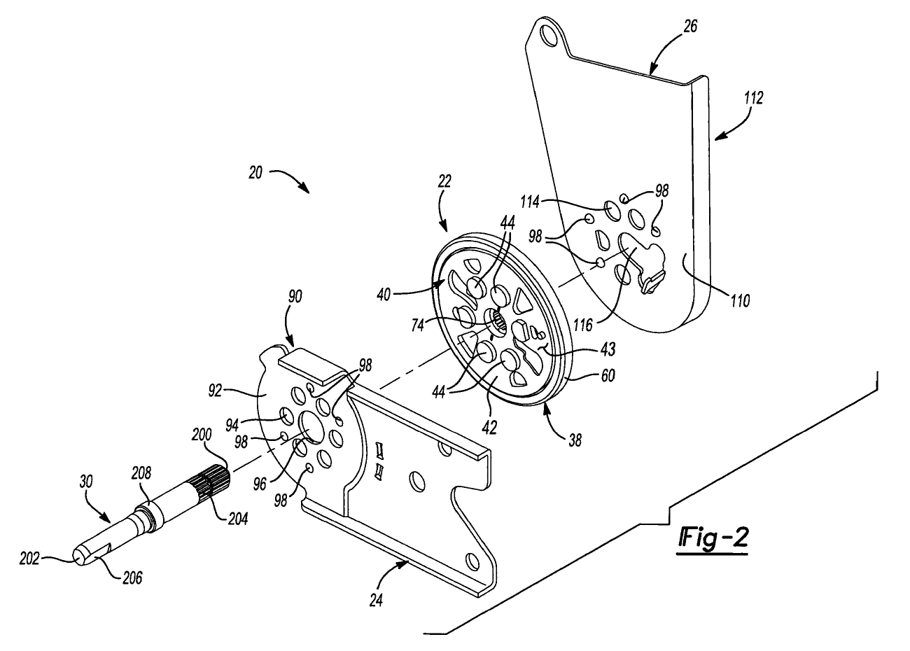

With reference to FIGS. 1 and 2, an adjustment assembly 20 is provided and may include an adjustment mechanism 22, a first structural component 24, a second structural component 26, and a pivot pin 30. The adjustment mechanism 22 prevents rotation of the second structural component 26 relative to the first structural component 24 in a locked state and permits rotation of the second structural component 26 relative to the first structural component 24 in an unlocked state. In one configuration, the adjustment mechanism 22, first structural component 24, and second structural component 26 are incorporated into a seat assembly 21 having a seatback 23 and a seat bottom 25 to selectively prevent rotation of the seatback 23 relative to the seat bottom 25.

The adjustment mechanism 22 may include a recliner mechanism 27 that selectively prevents rotation of the seatback 23 relative to the seat bottom 25. While the adjustment mechanism 22 is described as including a recliner mechanism 27, the adjustment mechanism 22 may alternatively or additionally include other adjustment mechanisms such as a floor-latch mechanism or a kneel mechanism. Furthermore, while the adjustment mechanism 22 may include various other adjustment mechanisms, the adjustment mechanism 22 will be hereinafter described and shown in the drawings as a recliner mechanism.

With reference to FIGS. 2-4, the adjustment mechanism 22 may include a housing 38 having a cover plate 40 extending over one side of adjustment mechanism 22. The cover plate 40 may include a main body 42 having an outer surface 43, a plurality of protrusions 44 extending from the outer surface 43, and a center aperture 46 extending therethrough. The housing 38 may further include a back plate 50 extending over an opposite side of the adjustment mechanism 22 than the cover plate 40. The back plate 50 may include a main body 52 having an outer surface 53, a plurality of protrusions 54 extending from the outer surface 53, and a center aperture 56 extending therethrough. Additionally, the housing 38 may include an outer casing 60 disposed around the peripheries of the cover plate 40 and the back plate 50 to couple the cover plate 40 and back plate 50.

The adjustment mechanism 22 may also include a variety of internal components disposed within the housing 38 that cooperate to selectively prevent rotation of the seatback 23 relative to the seat bottom 25. For example, the adjustment mechanism 22 may include a cam 70 disposed between the cover plate 40 and the back plate 50 having an aperture 72 for interaction with the pivot pin 30. The cam 70 may be disposed between cover plate 40 and back plate 50 such that the aperture 72 is aligned with center apertures 46, 56 of the cover plate 40 and back plate 50, respectively. Interaction between the cam 70 and the pivot pin 30 may toggle the adjustment mechanism 22 between the locked state and the unlocked state.

The adjustment mechanism 22 may be attached to at least one of the first structural component 24 and second structural component 26 to attach the adjustment mechanism 22 to the seat assembly 21. The first structural component 24 may include a first side 90 and a second side 92 opposite first side 90. The first structural component 24 may further include a plurality of apertures 94 and a center aperture 96 extending between the first and second sides 90, 92. The apertures 94 may correspond with the positions of the protrusions 44 of the adjustment mechanism 22 to align the adjustment mechanism 22 and first structural component 24. Additionally, the first structural component 24 may include a plurality of dimples 98 that may be respectively positioned proximate apertures 94. The dimples 98 may be integrally formed with the first structural component 24 during a stamping operation of the first structural component 24 or may be subsequently formed in the first structural component 24 by punching, for example. The dimples 98 may form a bump 100 in the first side 90 of the first structural component 24 and a recess 102 in the second side 92 of the first structural component 24 to create a point contact between the adjustment mechanism 22 and the first structural component 24.

The second structural component 26 may include a first side 110 and a second side 112 opposite the first side 110. The second structural component 26 may further include a plurality of apertures 114 and a center aperture 116 extending between the first and second sides 110, 112, whereby the apertures 114 correspond with the protrusions 54 of the adjustment mechanism 22. As described above with respect to the first structural component 24, the second structural component 26 may similarly include dimples 98 extending from the first side 110 proximate apertures 114.

The first and second structural components 24, 26 may be mounting brackets for attaching the adjustment mechanism to a seat frame 29 of the seat assembly 21. While the adjustment mechanism 22 is described and shown as being attached to the structural components 24, 26, prior to being attached to the seat assembly 21, the adjustment mechanism 22 may alternatively be directly attached to a structural component of the seat assembly 21, such as the seat frame 29.

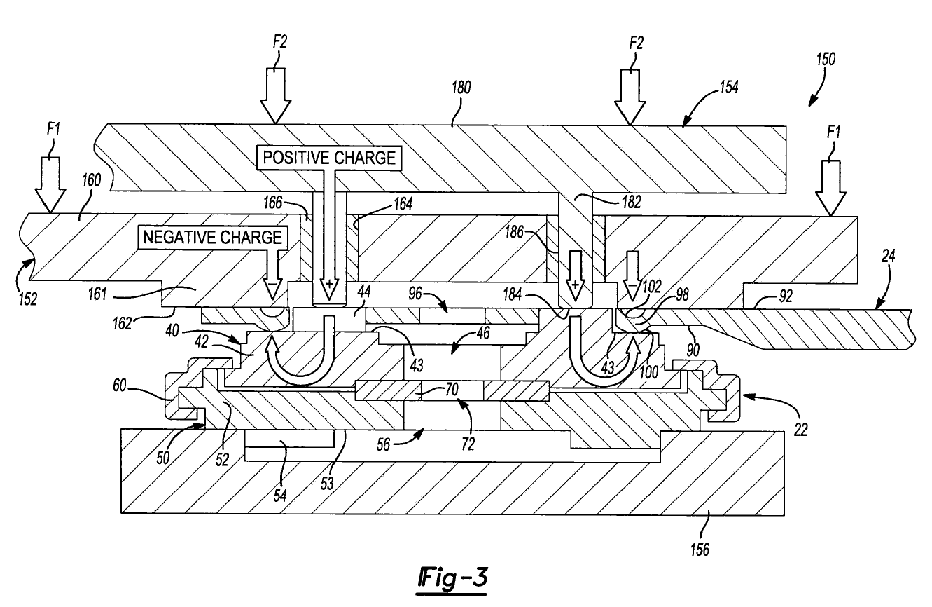

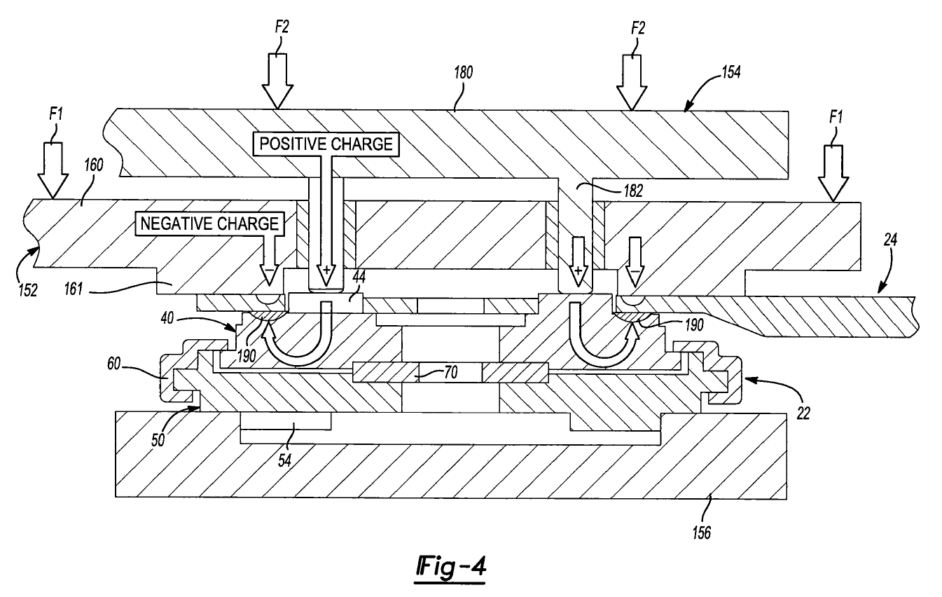

Referring to FIGS. 3 and 4, a capacitor-welding apparatus 150 according to the principles of the present disclosure will be described and shown. The capacitor-welding apparatus 150 interacts with the adjustment mechanism 22 to attach the adjustment mechanism 22 to the first and second structural components 24, 26 by applying a current to a single side of either the adjustment mechanism 22 or to either structural members 24, 26.

The capacitor-welding apparatus 150 may include a first welding tool 152, a second welding tool 154, and a pallet 156. The first welding tool 152 may include a main body 160 having projections 161 extending outwardly from the main body 160 that each define a contact surface 162. The first welding tool 152 may further include apertures 164 extending through the main body 160 and insulated bushings 166 disposed within apertures 164. The second welding tool 154 may include a main structure 180 and legs 182 extending from the main structure 180. The legs 182 may each include a distal end 184 and an outside surface 186 that are received through respective apertures 164 of the first welding tool 152. The pallet 156 may support the adjustment mechanism 22 proximate the first and second welding tools 152, 154 during welding of the adjustment mechanism 22 to the first structural component 24 or second structural member.

As shown in the figures, the first welding tool 152 may have a negative charge and the second welding tool 154 may have a positive charge. While the first welding tool 152 is described as including a negative charge and the second welding tool 154 is described as including a positive charge, it should be understood that the first welding tool 152 could alternatively include a positive charge and the second welding tool 154 could alternatively include a negative charge.

With reference to FIGS. 2-4, attachment of the adjustment mechanism 22 to the structural components 24, 26 using a capacitor-welding process will be described in detail. To attach adjustment mechanism 22 to the first structural component 24, the adjustment mechanism 22 is first supported on the pallet 156. Next, the first structural component 24 is positioned on the adjustment mechanism 22 with the first side 90 of the first structural component 24 facing the cover plate 40. The first side 90 may be disposed proximate the outer surface 43 of the cover plate 40 with the bumps 100 of dimples 98 contacting the outer surface 43 of the cover plate 40. Additionally, the protrusions 44 may extend into apertures 94 such that the center apertures 46, 56 of the adjustment mechanism 22 and first structural component 24, respectively, are aligned with one another.

Once the adjustment mechanism 22 is aligned with the first structural component 24, the first welding tool 152 may engage the first structural component 24. Specifically, the contact surface 162 may engage the second side 92 of the first structural component 24 proximate dimples 98. A first clamping force F1 may then be applied to the first welding tool 152.

Once the first welding tool 152 is engaged with the first structural component 24, the second welding tool 154 can engage the adjustment mechanism 22. The second welding tool 154 may be disposed proximate the first welding tool 152 with the legs 182 of the second welding tool 154 extending through apertures 164 and insulated bushings 166 such that the ends 184 of each leg 182 engage respective protrusions 44 of the adjustment mechanism 22. The outside surfaces 186 of each leg 182 engage the insulted bushings 166 to prevent the first and second welding tools 152, 154 from contacting one another and being directly electrically connected. A second clamping force F2 is then applied to the second welding tool 154.

With the above configuration, an electrical path or connection is formed between the projections 161 of the first welding tool 152, the dimples 98 of the first structural component 24, the main body 42 and protrusions 44 of the cover plate 40, and the legs 182 of the second welding tool 154. Because the first structural component 24 only contacts the main body 42 at the dimples 98, electricity is only conducted between the first structural component 24 and the main body via the dimples 98, and therefore limits the amount of energy passing between the first and second welding tools 152, 154. If a greater portion of side 92 were in contact with the main body 42, more electricity would flow between the first and second welding tools 152, 154 than would be required to fuse the first structural component to the cover plate 40.

As shown in FIGS. 3 and 4, the positive charge from the second welding tool 154 and the negative charge from the first welding tool 152 causes current to flow through the main body 42 and the protrusions 44 and into the dimples 98 of the first structural component. The flow of energy forms welds 190 (FIG. 4) to fuse first structural component 24 to cover plate 40. The welds 190 are formed generally from the dimples 98 to fuse the first structural component 24 to the adjustment mechanism 22 generally at the location of each dimple 98.

During the capacitor-welding process, the energy from the capacitor-welding apparatus 150 only travels between the cover plate 40 and the first structural component 24 due to interaction between the dimples 98 and the cover plate 40. Because the flow only lasts for a brief period of time and does not produce a significant amount of heat, damage to other components of the adjustment mechanism 22 (e.g., internal components) is inhibited. Furthermore, the configuration of the capacitor-welding apparatus 150 allows for both the first and second welding tools 152, 154 to be positioned near a single side of the adjustment mechanism 22 during a welding process such that each welding tool 152, 154 may be inserted and retracted from a single side of the adjustment mechanism 22 or first structural component 24.

After the first structural component 24 is attached to the adjustment mechanism 22, the second structural component 26 may be attached to the adjustment mechanism 22. In particular, the adjustment mechanism 22 and first structural component 24 may be supported on the pallet 156 with the back plate 50 facing away from the pallet 156. The second structural component 26 may be disposed proximate the adjustment mechanism 22 with the first side 110 of the adjustment mechanism 22 facing the back plate 50. In this position, the dimples 98 of the second structural component 26 contact the outer surface 53 of the back plate 50 to create a path for electricity to flow between the back plate 50 and the second structural component 26. Attachment of the second structural component 26 to the adjustment mechanism 22 is substantially similar to the attachment of the first structural component 24 to the adjustment mechanism 22 described above. Therefore, a description of the attachment of the second structural component 26 to the adjustment mechanism 22 is foregone.

The pivot pin 30 may engage the adjustment mechanism 22 to complete the adjustment assembly 20 once the adjustment mechanism 22 is attached to the first and second structural components 24, 26. The pivot pin 30 may include an elongate shape with a first end 200 and a second end 202. The pivot pin 30 may also include a grooved-outer portion 204 proximate the first end 200, flat portions 206 proximate the second end 202, and a center flange 208.

The first end 200 of the pivot pin 30 may extend into the center apertures 46, 56, 96, 116, and 72 of the cover plate 40, back plate 50, first structural component 24, second structural component 26, and center cam 70, respectively, with the grooved-outer portion 204 engaging the grooved-inner surface 74 of the center cam 70. With the grooved-inner surface 74 and the grooved-outer portion 204 engaged with each other, the pivot pin 30 can be rotated relative to the structural components 24, 26 to operate the adjustment mechanism 22 and permit relative rotation between the first and second structural components 24, 26. Such relative movement allows for selective rotation of the seatback 23 relative to the seat bottom 25. For example, if the first structural component 24 is attached to the seatback 23, rotation of the pivot pin 30 may release the adjustment mechanism 22 into the unlocked state to permit rotation of the first structural component 24 relative to the second structural component 26, and, thus, rotation of the seatback 23 relative to the seat bottom 25.

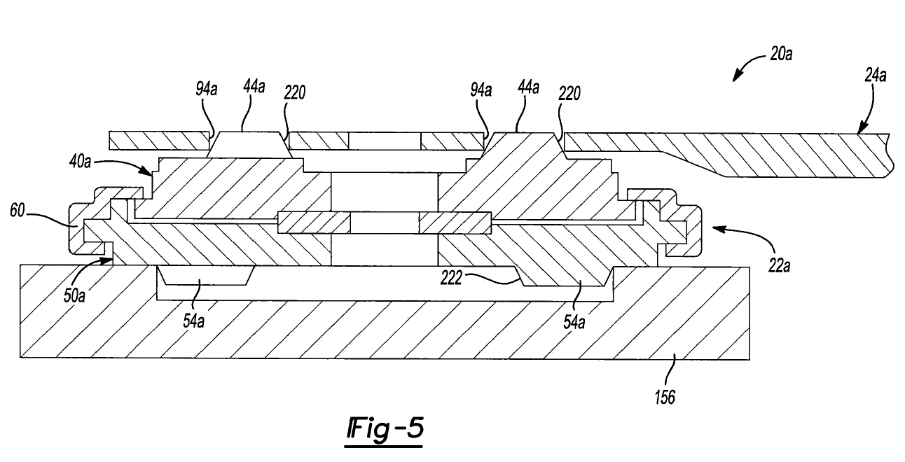

Referring to FIG. 5, an adjustment assembly 20a and adjustment mechanism 22a are provided. In view of the substantial similarity in structure and function of the components associated with the adjustment assembly 20 with respect to the adjustment assembly 20a, like reference numerals are used hereinafter and in the drawings to identify like components while like reference numerals containing letter extensions are used to identify those components that have been modified.

Adjustment mechanism 22a includes a cover plate 40a, a back plate 50a, and an outer casing 60. The cover plate 40a may include a plurality of protrusions 44a, while the back plate 50a may similarly include a plurality of protrusions 54a. The protrusions 44a and 54a may include tapered outer surfaces 220 and 222 to both facilitate insertion of the protrusions 44a, 54a into the first and second structural components 24a, 26, respectively, but also to improve contact therebetween.

The first structural component 24a may include apertures 94a that are sized to receive an intermediate portion of the tapered outer surfaces 220 of a respective protrusion 44a. Engagement between the apertures 94a and the tapered outer surfaces 220 of the adjustment mechanism 22a provides an interface where the first structural component 24a and adjustment mechanism 22a are joined. For example, the connection provides a path for electricity to travel between the first structural component 24a and the adjustment mechanism 22a. As such, the capacitor-welding apparatus 150, with operation similar to those discussed above with respect to adjustment mechanism 22, can be utilized to attach adjustment mechanism 22a and first structural component 24a. The second structural component 26 may be joined to the adjustment mechanism 22a in a similar fashion.

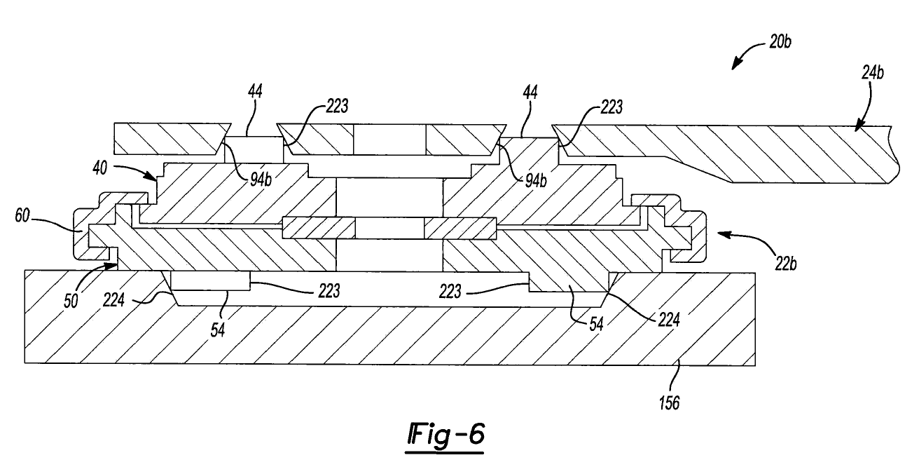

Referring now to FIG. 6, an adjustment assembly 20b and adjustment mechanism 22b are provided. In view of the substantial similarity in structure and function of the components associated with the adjustment assembly 20 with respect to the adjustment assembly 20b, like reference numerals are used hereinafter and in the drawings to identify like components while like reference numerals containing letter extensions are used to identify those components that have been modified.

As shown in FIG. 6, the adjustment mechanism 22b includes protrusions 44, 54 formed in the cover plate 40 and back plate 50, respectively, each having generally straight side surfaces 223. The protrusions 44, 54 are received within apertures 94b formed in the first structural component 24b. While the first structural component 24b will be described and shown hereinafter as including tapered apertures 94b, the second structural component 26 could similarly include tapered apertures for engagement with protrusions 54 to facilitate joining of the second structural component 26 and adjustment mechanism 22b.

The apertures 94b of the first structural component 24b include a taper and are sized to engage the straight outer surfaces 220 of each protrusion 44 of the cover plate 40 at an intermediate point on a surface of the tapered apertures 94b. Engagement between tapered apertures 94b and straight outer surfaces 220 provides an interface where the first structural component 24b and adjustment mechanism 22b are joined. For example, the connection may provide a path for electricity to travel between the first structural component 24b and the adjustment mechanism 22b. As such, the capacitor-welding apparatus 150 can be utilized to attach adjustment mechanism 22b and first structural component 24b.

What is claimed is:

1. An adjustment assembly for a seat assembly, the adjustment assembly comprising:
an adjustment mechanism; and
a first structural component positioned proximate said adjustment mechanism to create at least one electrical path between said adjustment mechanism and said first structural component, said electrical path receiving current from one side of one of said adjustment mechanism and said first structural component and transmitting said current to the other of said adjustment mechanism and said first structural member to fuse said adjustment mechanism to said first structural component.

2. The adjustment assembly of claim 1, wherein one of said adjustment mechanism and said first structural component includes at least one raised surface creating at least one point contact between said adjustment mechanism and said first structural member.

3. The adjustment assembly of claim 2, wherein said at least one raised surface is a dimple formed on an outer surface of said at least one of said adjustment mechanism and said first structural component.

4. The adjustment assembly of claim 3, wherein said adjustment mechanism and said structural component are fused together at said dimples via a capacitor-welding process.

5. The adjustment assembly of claim 2, wherein said electrical path flows through said at least one point contact.

6. The adjustment assembly of claim 1, wherein one of said adjustment mechanism and said first structural component includes at least one protrusion received by an aperture of the other of said adjustment mechanism and said first structural component.

7. The adjustment assembly of claim 6, wherein one of said at least one protrusion and said aperture includes a tapered surface.

8. The adjustment assembly of claim 6, wherein said electrical path extends through said at least one protrusion and said at least one aperture.

9. The adjustment assembly of claim 1, wherein said adjustment mechanism and said first structural component are joined by a capacitor-welding process.

10. A seat assembly comprising:
a seat bottom;
a seatback rotatably supported by said seat bottom; and
an adjustment assembly disposed between said seat bottom and said seatback, said adjustment assembly comprising:
an adjustment mechanism; and
a first structural component positioned proximate said adjustment mechanism to create at least one electrical path between said adjustment mechanism and said first structural component, said electrical path receiving current from one side of one of said adjustment mechanism and said first structural component and transmitting said current to the other of said adjustment mechanism and said first structural member to fuse said adjustment mechanism to said first structural component.

11. The seat assembly of claim 10, wherein one of said adjustment mechanism and said first structural component includes at least one raised surface creating at least one point contact between said adjustment mechanism and said first structural member.

12. The seat assembly of claim 11, wherein said at least one raised surface is a dimple formed on an outer surface of said at least one of said adjustment mechanism and said first structural component.

13. The seat assembly of claim 12, wherein said adjustment mechanism and said structural component are fused together at said dimples via a capacitor-welding process.

14. The seat assembly of claim 11, wherein said electrical path flows through said at least one point contact.

15. The seat assembly of claim 10, wherein one of said adjustment mechanism and said first structural component includes at least one protrusion received by an aperture of the other of said adjustment mechanism and said first structural component.

16. The seat assembly of claim 15, wherein one of said at least one protrusion and said aperture includes a tapered surface.

17. The seat assembly of claim 15, wherein said electrical path extends through said at least one protrusion and said at least one aperture.

18. The seat assembly of claim 10, wherein said adjustment mechanism and said first structural component are joined by a capacitor-welding process.

19. A method comprising:
positioning a first structural component relative to an adjustment mechanism;
moving one of a positively charged tool and a negatively charged tool in a first direction and into engagement with an outer surface of one of said first structural component and said adjustment mechanism;
moving the other of said positively charged tool and said negatively charged tool in said first direction and into engagement with an outer surface of the other of said first structural component and said adjustment mechanism; and
providing a current flowing between said positively charged tool and said negatively charged tool to fuse said adjustment mechanism to said first structural component.
